(19) United States
(12) Patent Application Publication
(10) Pub. No.: US 2009/0271801 A1
(43) Pub. Date: Oct. 29, 2009

(54) Split stage call sequence restoration method

(76) Inventors: Stanislav V. Bratanov, Nizhniy Novgorod (RU); Alexei Alexandrov, Nizhniy Novgorod (RU)

Correspondence Address: INTEL/BSTZ;BLAKELY SOKOLOFF TAYLOR & ZAFMAN LLP, 1279 OAKMEAD PARKWAY, SUNNYVALE, CA, 94085-4040, US

(21) Appl. No.: 11/628,012

(22) PCT Filed: Aug. 30, 2006
(86) PCT No.: PCT/RU06/00463

§ 371 Date: Nov. 27, 2006

(51) Int. Cl. G06F 9/46

(52) U.S. Cl. 718/108

(57) ABSTRACT

Embodiments of the present invention provide for collecting a minimal subset of task execution context in real time and for restoring the task execution context and performing procedure frame unwinding operations at a post-processing stage. A first data structure may be constructed in real time to contain procedure linkage information along with references to the memory area or to a processor register context where each procedure linkage information element (procedure return address or a procedure frame pointer) was originally found. Procedure return addresses may be determined by decoding the instruction preceding the address in question and checking if it is a procedure call instruction. Procedure return addresses may also be determined using other methods (e.g., by checking whether the memory region the address in question belongs to is executable) if the probability of retrieving the correct result is acceptable for a particular area of application of an embodiment of the present invention. Procedure frame pointers may be determined as the conventional memory area elements whose value points back to the conventional memory area. Procedure frame pointers, depending on particular processor architecture, may also have other properties that differentiate them from other elements of the conventional memory area. The conventional memory area for purposes of the present invention may be non-contiguous. The contents of first data structure may then be employed in reconstruction of the task execution environment at the post-processing stage. Then, the procedure frame unwinding operations may be performed over the restored task execution context.

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

1. Field

The present invention relates generally to the computer program performance monitoring and analysis domain and, more specifically, to low intrusive methods of program logic restoration, such as constructing statistical control flow graphs and revealing information on procedure call sequences.

2. Description

The ability to reconstruct program flow logic and correlate it with performance characteristics, while employing low-overhead statistical data collection methods, is essential for modern computer program performance monitoring systems. One of the most popular solutions is to build a statistical call graph to restore call sequences for each statistically determined performance hotspot in a program's code.

Various real-time call sequence restoration techniques (e.g., based on function call instrumentation or stack unwinding in accordance with unwinding rules generated by a compiler) are excessively intrusive, which results in distorted performance characteristics.

While the systems that try to correlate performance information collected in real time with the results of an independent program control flow analysis are less intrusive, they suffer from poorer precision, since no information on the actual program execution state is preserved along with performance characteristics (to decrease the intrusiveness) and

the correct correspondence between such performance characteristics and independently determined program execution states cannot be established.

Therefore, a need exists for the capability to enable low-intrusive and precise control flow restoration by preserving the minimal and sufficient information about the actual program execution states in real time, in a manner that provides for correlation of performance monitoring results with the program states at the post-processing stage.

### BRIEF DESCRIPTION OF THE DRAWINGS

The features and advantages of the present invention will become apparent from the following detailed description of the present invention in which:

FIG. 1 is a diagram illustrating the relationship between processor execution context, stack memory, and internal structures at the stage of collecting procedure linkage information in accordance with an embodiment of the present invention;

FIG. 2 is a diagram illustrating the restoration of limited task execution context employed in the process of stack unwinding in accordance with an embodiment of the present invention;

FIG. 3 is a flow diagram illustrating the process of collecting procedure linkage information from the task execution context according to an embodiment of the present invention; and

FIG. 4 is a flow diagram illustrating the process of call sequence restoration according to an embodiment of the present invention.

### DETAILED DESCRIPTION

An embodiment of the present invention is a method that provides for efficient program control flow restoration by introducing a two-staged procedure frame unwinding algorithm. The efficiency in control flow restoration may be achieved by collecting a minimal amount of procedure linking information from the stack in real time, delaying the actual procedure frame unwinding operations until the program execution is over, and thus minimally affecting the behavior of the program being analyzed. Then, at the post-processing stage, the limited execution state of the program may be restored in accordance with the collected data, and the time-consuming procedure frame unwinding may be performed.

Any reference in the specification to “stack”, “procedure stack frame”, or “frame pointer” should not be construed in a limiting sense with regard to computer architectures that have no explicit support for stack memory and stack manipulation instructions, since the terms in question relate more to software convention rather than a particular computer system implementation, and denote a memory area to contain procedure linkage information, procedure local execution context, and a reference to the local execution context, respectively. A reference to the above terms should be interpreted as referring to any type of memory (being static or dynamic random-access memory, register files, or similar logic) that is conventionally used to store procedure linkage information and procedure local execution contexts.

Reference in the specification to “one embodiment” or “an embodiment” of the present invention means that a particular feature, structure or characteristic described in connection with the embodiment is included in at least one embodiment of the present invention. Thus, the appearances of the phrase “in one embodiment” appearing in various places throughout the specification are not necessarily all referring to the same embodiment.

The following definitions may be useful for understanding embodiments of the present invention described herein.

A Statistical Call Graph is a partial program control flow graph reconstructed for statistically discernible code elements (e.g., functions) with performance information assigned to each node; it is typically implemented as a combination of time- or event-based sampling and call sequence restoration upon each sample.

Call Sequence Restoration is a process of determination of the actual sequence of function calls that led to any given code element (address, function); it is typically implemented as stack unwinding.

A Stack for purposes of the present specification is a conventional memory area dedicated to contain procedure linkage information. The stack does not need to occupy a contiguous memory region.

Procedure linkage information (PLI) is a partial execution context necessary to establish correct execution transfer between nested procedures (the PLI includes at least a procedure return (link) address; it may also include a frame pointer that provides information on the correct stack frame size allocated for the procedure).

A Procedure Stack Frame is a stack area allocated for each function to store function local execution context, preserved execution context of upper-level functions, a procedure return (link) address, and input parameters.

Stack Frame or Procedure Frame Unwinding is a process of restoring a function's local execution context, interpreting its contents, determining the size of the function's stack frame and locating the return (link) address to the function's caller. The process may be repeated for each function along the call chain.

Unwinding Rules are a set of pseudo-instructions associated (ideally) with each procedure frame to enable procedure stack frame unwinding. For a given execution point, unwinding rules determine how many bytes of local data need to be skipped to find the previous stack frame and the location of preserved processor registers.

Compiler-Generated Unwinding Information is a set of Unwinding Rules generated by a compiler during the source code compilation. Usually, this information is stored as part of an executable binary.

Task Execution Context is a dataset describing the state of a task executed by a processor at a given point in time. The dataset includes processor context (values of processor registers) and stack memory area contents. The sequence of nested function calls being part of the task state is unambiguously determined by the task execution context. The contents of data and code segments are not included into the task execution context as they may be shared among multiple tasks and thus cannot contain unique information describing the activity of a particular task.

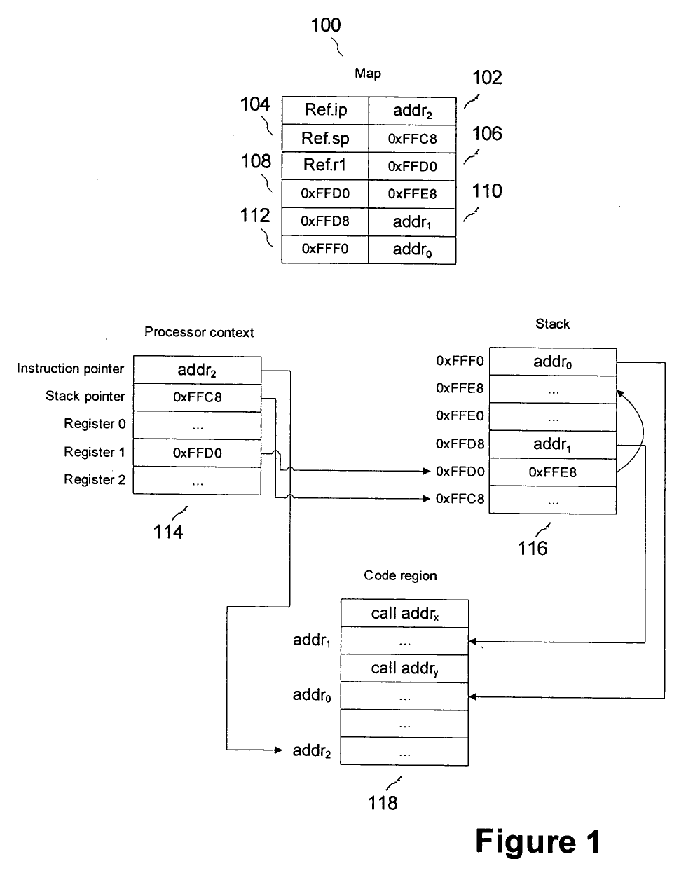

FIG. 1 is a diagram illustrating the relationship between processor execution context, stack memory, and internal structures at the stage of collecting procedure linkage information. According to the figure, map 100 may be formed to preserve procedure linkage information from the task execution context. The task execution context may comprise at least processor context 114 and stack memory 116. The procedure linkage information may comprise at least procedure return (link) addresses and frame pointers.

The frame pointers may be determined as any element of the task execution context that has a value in between the stack base and the current stack address being analyzed. The above assumption is guaranteed to yield results relevant for procedure frame unwinding in case a compiler that was used to translate a procedure in question generated efficient procedure frame layout, with at most one level of indirection for all stack accesses within the procedure. Hence any data referring to stack frames should have values within stack limits, and thus may be captured as frame pointers in map 100.

It has to be noted here that since modern compilers tend to the efficiency of procedure stack frames and their application binary interface specifications explicitly prohibit indirect frame pointer usage, the above assumption should not be considered as a limitation to the scope of applicability of the present invention.

The procedure link addresses may be differentiated by decoding a processor instruction immediately preceding such addresses. Thus, in case a stack element contains an address that points to an executable code region (block 118 in the example of FIG. 1) and the processor instruction immediately preceding such an address is a procedure call instruction, the address may be considered a procedure link address and stored in map 100.

According to the figure, each element of map 100 may be associated with a reference to the actual location of the element's value within the task execution context. The reference to a location of a procedure linkage information element should unambiguously identify the location, and may comprise an offset to a stack base (or to a stack pointer) or, as depicted in FIG. 1, a memory address within the stack limits; the reference may also comprise an index of a processor register, or the position of an element within the map may be selected in accordance with the register index.

One embodiment of the present invention may have a value of the instruction pointer register stored in element 102 of map 100 as the value of that register always determines the procedure being currently executed. Element 104 may contain a value of the stack pointer register as the register provides information on the actual stack level for the currently executed procedure. Element 106 may contain a value of register r1 in case its value falls within the stack limits. Elements 108 through 110 may contain values, as found in the stack memory region, which either point back to stack memory area 116 or to executable code region 118.

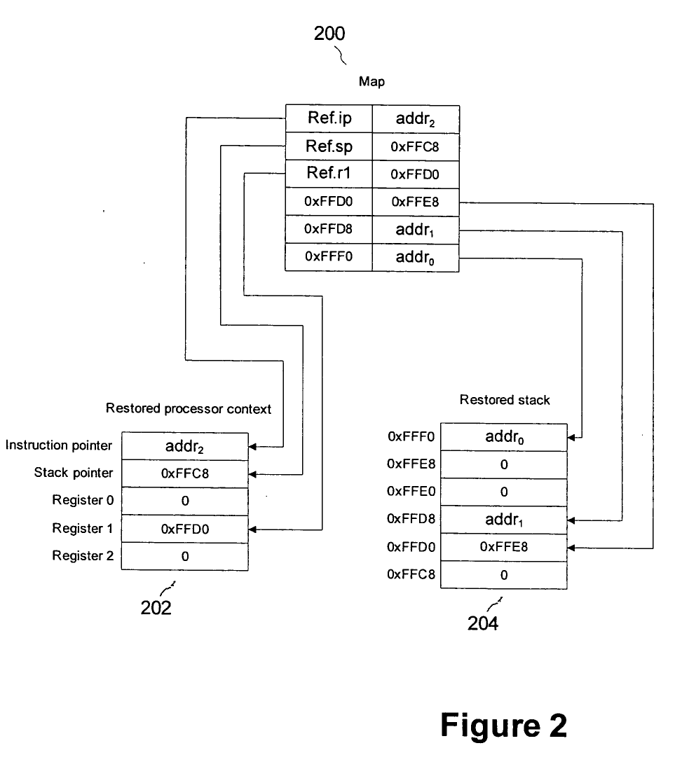

FIG. 2 is a diagram illustrating the restoration of limited task execution context employed in the process of stack unwinding. As depicted in the figure, the procedure linkage information preserved in map 200 may be used for partial restoration of the task execution context in order to perform procedure frame unwinding after the data collection has been done. According to the figure, the references stored along with each element of map 200 determine the position of the corresponding element within the task execution context. Thus, from the first three elements of map 200 the contents of processor registers may be restored. For registers not referenced by the map, default values may be assumed (zero in the present example). The rest of the elements of map 200 may provide for restoration of the stack memory area, the borders of the stack may be determined by the value of the restored stack pointer register and the highest reference to the stack stored in map 200.

The restored limited execution context may be considered sufficient for procedure frame unwinding as it provides information on the procedure being executed at the time the data was collected, defines the location of the memory area that is dedicated to contain procedure linkage information, and preserves all procedure link addresses and frame pointers that existed at the time the data was collected.

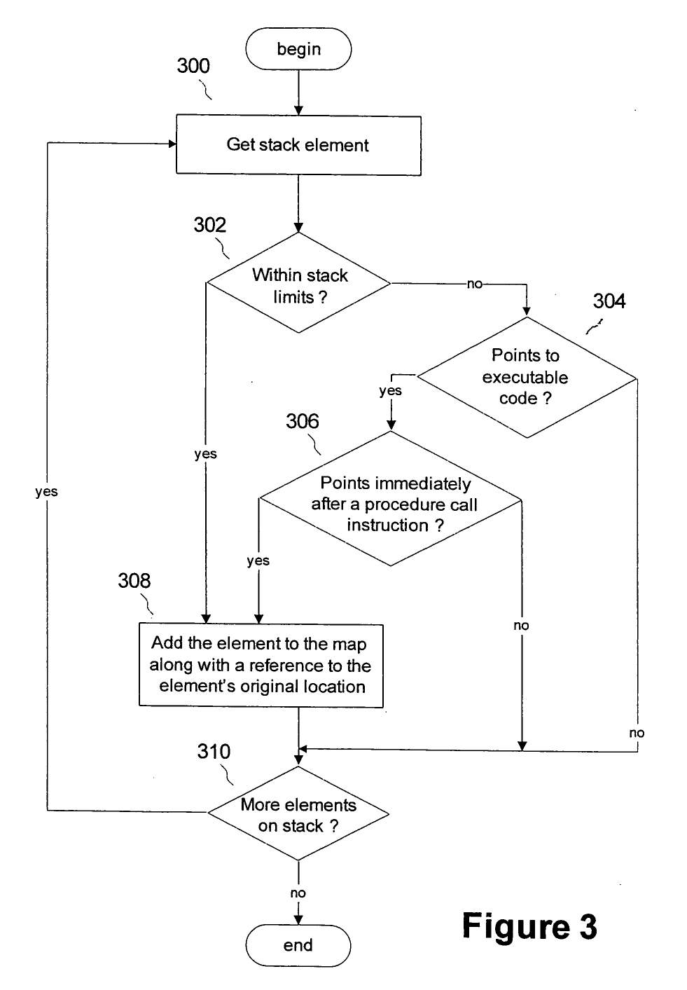

FIG. 3 is a flow diagram illustrating the process of collecting procedure linkage information from the task execution context in accordance with an embodiment of the present invention. According to the figure, the value of an element of the task execution context may be obtained at block 300. Then, the check as to whether the obtained value points to the stack memory may be performed at block 302.

In case the value is within the stack limits, the current element of the task execution context may be considered a frame pointer and added to the map of PLI elements at block 308.

Otherwise, the check if the obtained value points to an executable code region may be performed at block 304. In case the check yields true, the value may be interpreted as an address within a code region, and a further check for the type of the processor instruction preceding that address may be performed at block 306. If the preceding processor instruction is determined to be a procedure call, the current element of the task execution context may be considered a procedure link address and added to the map of PLI elements at block 308.

One skilled in the art will recognize the option of combining the checks at blocks 304 and 306, or even eliminating unnecessary checks in case they cannot be implemented efficiently in particular execution environments, without leaving the scope of the present invention.

The process of collecting procedure linkage information may be repeated until all elements of the task execution context have been processed (as checked at block 310).

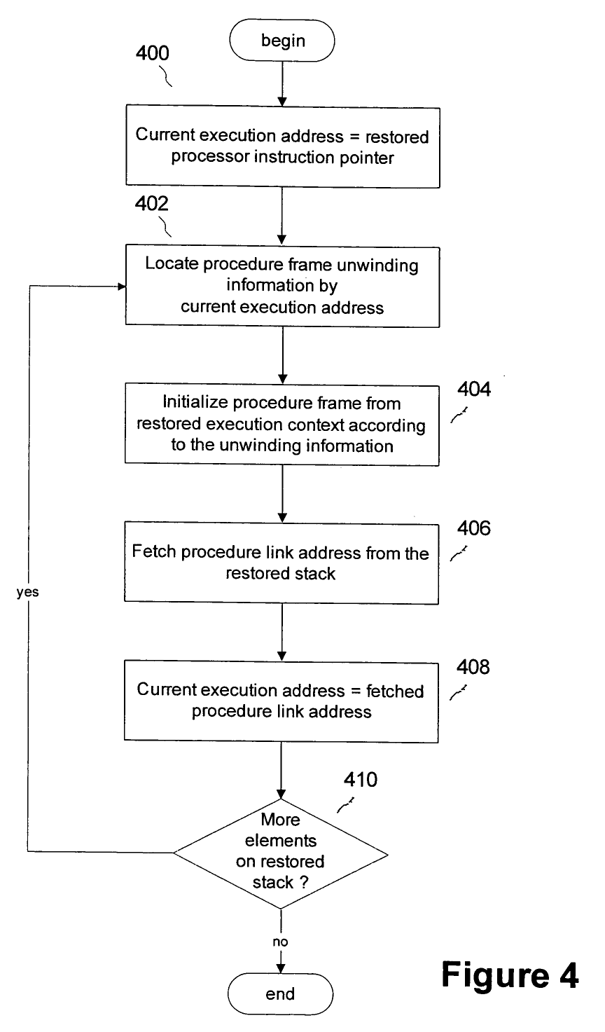

FIG. 4 is a flow diagram illustrating the process of call sequence restoration from the restored task execution context. According to the figure, the current execution address may be initially assigned the value of the restored processor instruction pointer register at block 400. Then, at block 402, the procedure frame unwinding information may be located in accordance with the current execution address. Typically, modern compilers associate each address range within an executable binary with the unwinding information, so that each execution address unambiguously corresponds to a set of unwinding rules.

Once the unwinding rules have been located and analyzed, the procedure frame may be initialized from the restored limited execution context at block 404. As the result, the fields of the procedure frame that affect the process of frame unwinding will be assigned the same values they had at the time the data was collected. Other fields will receive default values (zeros in the examples of FIGS. 1 and 2).

Since the rules for obtaining the link address for a procedure being analyzed are known, the link address may be fetched from the restored execution context at block 406. Then, at block 408 the current execution address may be assigned the value of the fetched procedure link address, and the process of call sequence restoration may be repeated for the less deeply nested procedure until the end of the restored execution context is reached (as checked at block 410).

It should be noted that implementing any known method of stack frame unwinding to no extent limits the scope of the present invention as the only difference between the above described procedure and traditional methods of stack frame unwinding in connection with embodiments of the present invention is that the former is performed over the restored (or simulated) data rather than the actual processor registers and stack memory contents.

For a C language example of an embodiment of the present invention refer to Appendix A. The goal of this code is to illustrate how the minimal subset of task execution context may be collected in real time in a manner that enables further restoration of the task execution context relevant to the stack unwinding at the post-processing stage.

In the provided example all stack elements that point back to the stack area in between the highest stack address and the address being currently processed are collected. In addition, for all stack elements pointing to other memory regions, the memory contents immediately preceding the address specified in the stack element are analyzed. In case the results of the analysis indicate the presence of a procedure call instruction, the stack element is considered a valid procedure return (link) address and is also collected.

One skilled in the art will recognize the option of implementing different return address validation schemes—decoding preceding instructions, checking properties of a memory region, or any other scheme—without deviating from the scope of the present invention as long as such schemes provide for determination of the return address with an acceptable level of probability in accordance with the method introduced by the present invention.

Furthermore, one skilled in the art will recognize that embodiments of the present invention may be implemented in other ways and using other programming languages.

The techniques described herein are not limited to any particular hardware or software configuration; they may find applicability in any computing or processing environment. The techniques may be implemented in logic embodied in hardware, software, or firmware components, or a combination of the above. The techniques may be implemented in programs executing on programmable machines such as mobile or stationary computers, personal digital assistants, set top boxes, cellular telephones and pagers, and other electronic devices, that each include a processor, a storage medium readable by the processor (including volatile and non-volatile memory and/or storage elements), at least one input device, and one or more output devices. Program code is applied to the data entered using the input device to perform the functions described and to generate output information. The output information may be applied to one or more output devices. One of ordinary skill in the art may appreciate that the invention can be practiced with various computer system configurations, including multiprocessor systems, minicomputers, mainframe computers, and the like. The invention can also be practiced in distributed computing environments where tasks may be performed by remote processing devices that are linked through a communications network.

Each program may be implemented in a high level procedural or object oriented programming language to communicate with a processing system. However, programs may be implemented in assembly or machine language, if desired. In any case, the language may be compiled or interpreted.

Program instructions may be used to cause a general-purpose or special-purpose processing system that is programmed with the instructions to perform the operations described herein. Alternatively, the operations may be performed by specific hardware components that contain hardwired logic for performing the operations, or by any combination of programmed computer components and custom hardware components. The methods described herein may be provided as a computer program product that may include a machine readable medium having stored thereon instructions that may be used to program a processing system or other electronic device to perform the methods. The term “machine readable medium” used herein shall include any medium that is capable of storing or encoding a sequence of instructions for execution by the machine and that cause the machine to perform any one of the methods described herein. The term “machine readable medium” shall accordingly include, but not be limited to, solid-state memories, optical and magnetic disks, and a carrier wave that encodes a data signal. Furthermore, it is common in the art to speak of software, in one form or another (e.g., program, procedure, process, application, module, logic, and so on) as taking an action or causing a result. Such expressions are merely a shorthand way of stating the execution of the software by a processing system to cause the processor to perform an action or produce a result.

While this invention has been described with reference to illustrative embodiments, this description is not intended to be construed in a limiting sense. Various modifications of the illustrative embodiments, as well as other embodiments of the invention, which are apparent to persons skilled in the art to which the invention pertains are deemed to lie within the spirit and scope of the invention.

### APPENDIX A © 2006 Intel Corporation

A C code example for the real-time stack collection part of the split-stage call sequence restoration method.

The present example shows one possible implementation of the algorithm that collects data from the stack in real time. The amount of the collected data should be minimally sufficient to enable stack unwinding at the post-processing stage, when the actual execution context no longer exists.

The goal of this code is to collect all stack elements that point back to the stack area in between the highest stack address and the address being currently processed. In addition, for all stack elements pointing to other memory regions, the memory contents immediately preceding the address specified in the stack element are analyzed. In case the results of the analysis indicate the presence of a procedure call instruction, the stack element is also collected.

All of the collected stack element values are annotated with a pointer to their original location in stack memory in order to enable further restoration of the relevant stack contents at the off-line stack unwinding stage.

The data collection illustrated by this code example is combined with the efficient mapping of stack contents that provides for minimizing the number of operations to be performed.

char* altstack_sampling(struct stack_control_t* stk, void** top, void** bottom)
{

void** addr;
void** altaddr;
void** prev_stack;
void** prev_top;
void** curr_stack;
void** curr_top;
void** region_start;
void** region_end = 0;
void** similarity_top;
void* sp = 0;
void* ip = 0;
void* context = 0;
char* retptr = 0;
int counter;

/// initialize pointers to the previous and current alt. stack base and top

prev_stack = (void**)stk−>active_stack;
prev_top = (void**)stk−>curr_max;
if(prev_stack == prev_top) /// the stack wasn't sampled yet
{
curr_stack = prev_stack;

curr_top = prev_top;

}
else
{

if(prev_stack == (void**)stk−>sbuf)
{

curr_stack = curr_top = (void**)(stk−>sbuf + stk−>bsizediv2);

}
else
{

curr_stack = curr_top = (void**)stk−>sbuf;

}

}
region_start = top;

/// search for the first saved alt. esp >= esp (region_start)
/// return found esp value (as region_end) and a pointer to the esp-addr pair (similarity_top)

if(prev_stack == prev_top || (void**)(((char*)prev_stack) + stk−>bsizediv2) == prev_top)
{

region_end = bottom;
similarity_top = prev_top;

}
else
{

similarity_top = 0;
for(addr = prev_stack; addr < prev_top; addr += 2)
{

if((void**)*addr >= region_start)
{

if(*(void**)*addr == *(addr + 1))
{

if(!similarity_top)
{

region_end = (void**)*addr;
similarity_top = addr;

}

}
else
{

similarity_top = 0;

}

}

}
if(!similarity_top)
{

region_end = bottom;
similarity_top = prev_top;

}

}

/// copy the filtered esp/return addr pairs from the search region
/// within the real stack to the current alt. stack
/// (said pairs may be formed as a result of unwinding)

for(counter = 0; counter < 2; counter++)
{

if(!counter)
{

addr = region_start;
altaddr = curr_stack;

}
for(; addr <= region_end && addr < bottom && altaddr < (void**)(((char*)curr_stack) +

stk−>bsizediv2);)

{

context = get_stack_frame (&sp, &ip, context);
if(!context)
{

break;

| } | |
|---|---|
| addr = (void**)sp; | |
| *altaddr = (void*)addr; | |
| *(altaddr + 1) = ip; | /// addr MUST point to IP value on the stack for x86 |

/// platforms (*(altaddr + 1) = *addr)

altaddr += 2;
if(addr == region_end)
{

break;

}

}
if(!context)
{

similarity_top = prev_top;
break;

}
if(!counter)
{

if(similarity_top == prev_top)
{

break;

}
if(sp != *similarity_top)
{

region_end = bottom;
similarity_top = prev_top;
continue;

}
similarity_top += 2;
break;

}

}
curr_top = altaddr;
retptr = (char*)curr_top;

/// copy pairs from the previous to the current alt. stack from the similarity_top
/// upto curr_max (i.e., prev_top)

for(addr = similarity_top, altaddr = curr_top; addr < prev_top && altaddr <

(void**)(((char*)curr_stack) + stk−>bsizediv2); addr += 2)

{

*altaddr = *addr;
*(altaddr + 1) = *(addr + 1);
altaddr += 2;

}
curr_top = altaddr;

/// update alt. stack control structure

stk−>active_stack = (char*)curr_stack;
stk−>curr_max = (char*)curr_top;
return retptr;

}
struct_stack_control_t
{

| | |
|---|---|
| char* sbuf; | /// alt. stack buffer (0 if not allocated) |
| int bsizediv2; | /// buffer size (total) divided by 2 |
| char* active_stack; | /// pointer to the active buffer half |
| char* curr_max; | /// maximum nesting level of a previous sample |

};
struct unwind_context_t
{

CONTEXT context;
STACKFRAME64 stack;

};
/// takes a pointer to a stack pointer and returns a new value of the pointer to the next
/// stack frame (via the same input parameter)
/// the returned stack pointer should point to the place where the returned ip is actually stored
/// context is an opaque pointer to an unwinding context
/// returns NULL in case of error, or a pointer to context
void* get_stack_frame(void** sp, void** ip, void* context)
{

thread_desc_t* ctx;
void** curr_sp;
void* value;
unsigned char opcode[8];
int bytes_read;
int valid;
int i;
if(!context)
{

ctx = g_proc_desc.curr_thread_desc;
ctx−>unwind_context−>curr_sp = curr_sp = (void**)ctx−>unwind_context−>context.Esp;

}
else
{

ctx = (thread_desc_t*)context;
curr_sp = ctx−>unwind_context−>curr_sp;

}
for(; (void*)curr_sp < ctx−>stack_base; curr_sp++)
{

/// filter the return addresses and frame pointers
value = read_remote_address((void*)curr_sp);
if(value >= curr_sp && value < ctx−>stack_base && !((size_t)value & (sizeof(void*) − 1)))
{

*ip = value;
*sp = curr_sp;
ctx−>unwind_context−>curr_sp = curr_sp + 1;
return ctx;

}
if(ReadProcessMemory(g_proc_desc.proc_handle, (void*)((char*)value − MAX_INSTR_SIZE),

opcode, 8, &bytes_read))

{

valid = 0;
valid += (opcode[2] == CALLND_OPCODE);
valid += (opcode[0] == CALLNI_OPCODE && (opcode[1] & CALLNI_OPMASK) == CALLNI_OPEXT);
valid += (opcode[4] == CALLNI_OPCODE && (opcode[5] & CALLNI_OPMASK) == CALLNI_OPEXT);
valid += (opcode[5] == CALLNI_OPCODE && (opcode[6] & CALLNI_OPMASK) == CALLNI_OPEXT);
if(valid)
{

*ip = value;
*sp = curr_sp;
ctx−>unwind_context−>curr_sp = curr_sp + 1;
return ctx;

}

}

}
ctx−>unwind_context−>curr_sp = curr_sp;
return 0;

}

What is claimed is:

1. In a system restoring program control flow information, a method comprising:
forming a first data structure from a task execution context at a real-time data collection stage;
restoring a limited execution context from the contents of the first data structure at a post-processing stage; and
performing procedure frame unwinding operations over the restored limited execution context.

2. The method of claim 1, wherein task execution context comprises at least a processor register state that affects procedure execution and a memory area dedicated to store procedure linkage information.

3. The method of claim 1, wherein limited execution context comprises the minimal subset of the task execution context sufficient for procedure frame unwinding.

4. The method of claim 1, wherein the first data structure comprises procedure linkage information elements associated with references to original locations of the elements within the task execution context.

5. The method of claim 4, wherein procedure linkage information comprises procedure link addresses and procedure frame pointers.

6. The method of claim 5, wherein procedure link addresses are determined by at least one of checking whether the addresses belong to an executable memory region and checking whether a processor instruction immediately preceding at least one of the addresses is a procedure invocation instruction.

7. The method of claim 5, wherein procedure frame pointers comprise data records that provide information on at least the size of a local procedure frame allocated for a procedure.

8. The method of claim 7, further comprising determining procedure frame pointers by checking whether the pointer values are within the range of the memory addresses starting from the current address that contains the frame pointer being checked, if the processor architecture provides for direct access to the memory area from procedure code.

9. An article comprising: a machine accessible medium having a plurality of machine readable instructions, wherein when the instructions are executed by a processor, the instructions provide for restoring program control flow information by:
forming a first data structure from a task execution context at a real-time data collection stage;
restoring a limited execution context from the contents of the first data structure at a post-processing stage; and
performing procedure frame unwinding operations over the restored limited execution context.

10. The article of claim 9, wherein task execution context comprises at least a processor register state that affects procedure execution and a memory area dedicated to store procedure linkage information.

11. The article of claim 9, wherein limited execution context comprises the minimal subset of the task execution context sufficient for procedure frame unwinding.

12. The article of claim 9, wherein the first data structure comprises procedure linkage information elements associated with references to the original location of the elements within the task execution context.

13. The article of claim 12, wherein procedure linkage information comprises procedure link addresses and procedure frame pointers.

14. The article of claim 13, wherein procedure link addresses are determined by at least one of checking whether the addresses belong to an executable memory region and checking whether a processor instruction immediately preceding at least one of the addresses is a procedure invocation instruction.

15. The article of claim 13, wherein procedure frame pointers comprise data records that provide information on at least the size of a local procedure frame allocated for a procedure.

16. The article of claim 15, wherein procedure frame pointers are determined by checking whether the pointer values are within the range of the memory addresses starting from the current address that contains the frame pointer being checked, if the processor architecture provides for direct access to the conventional memory area from procedure code.

17. A system that restores program control flow information, comprising:
logic to form a first data structure from a task execution context at a real-time data collection stage;
logic to restore a limited execution context from the contents of the first data structure at a post-processing stage; and
logic to perform procedure frame unwinding operations over the restored limited execution context.

18. The system of claim 17, wherein task execution context comprises at least a processor register state that affects procedure execution and a memory area dedicated to store procedure linkage information.

19. The system of claim 17, wherein limited execution context comprises the minimal subset of the task execution context sufficient for procedure frame unwinding.

20. The system of claim 17, wherein the first data structure comprises procedure linkage information elements associated with references to the original location of the elements within the task execution context.

21. The system of claim 20, wherein procedure linkage information comprises procedure link addresses and procedure frame pointers.

22. The system of claim 21, wherein procedure link addresses are determined by at least one of checking whether the addresses belong to an executable memory region and checking whether a processor instruction immediately preceding at least one of the addresses is a procedure invocation instruction.

23. The system of claim 21, wherein procedure frame pointers comprise data records that provide information on at least the size of a local procedure frame allocated for a procedure.

24. The system of claim 23, wherein procedure frame pointers are determined by checking whether the pointer values are within the range of the memory addresses starting from the current address that contains the frame pointer being checked, if the processor architecture provides for direct access to the memory area from procedure code.
